(19) United States
(12) Patent Application Publication
(10) Pub. No.: US 2019/0057271 A1
(43) Pub. Date: Feb. 21, 2019

(54) IMAGE PROCESSING METHOD, PHOTOGRAPHING DEVICE AND STORAGE MEDIUM

(71) Applicant: MediaTek Singapore Pte. Ltd., Singapore (SG)

(72) Inventor: Ruijun ZHANG, Shanghai (CN)

(21) Appl. No.: 16/004,561

(22) Filed: Jun. 11, 2018

(30) Foreign Application Priority Data
Aug. 15, 2017 (CN) 201710699335.0

(51) Int. Cl. G06K 9/20; H04N 5/232; H04N 5/907; G06K 9/46

(52) U.S. Cl. CPC G06K 9/2054; H04N 5/23212; G06K 9/46; G06K 9/209; H04N 5/907

(57) ABSTRACT

An image processing method, a photographing device and a storage medium are disclosed in the invention. The image processing method includes: determining whether a physiological feature in a current collection area needs to be detected according to a photographing parameters of a lens during capturing; and directly storing an image captured from the current collection area when the physiological feature in the current collection area does not need to be detected; or detecting the physiological feature in the current collection area and processing the captured image when the physiological feature in the current collection area needs to be detected.

### CROSS REFERENCE TO RELATED APPLICATIONS

This application claims priority to Chinese Patent Application No. 201710699335.0 filed on Aug. 15, 2017 in the China Intellectual Property Office, the contents of which are incorporated by reference herein.

### BACKGROUND OF THE INVENTION

### Field of the Invention

The present disclosure describes embodiments generally related to the field of image processing technology, and more particularly, related to an image processing method, a photographing device and a storage medium.

### Description of the Related Art

As imaging technology develops, consumers are demanding cameras that are able to capture images at higher and higher resolutions. High-resolution images provide more detail, which can be used in conjunction with advanced image restoration technology to fully or partially restore entire images. With the development of photographing devices, the images captured by the photographing devices usually have higher resolutions.

When a person takes a photograph in his or her daily life, the photograph usually includes personal physiological features such as fingerprints, palm prints, irises, etc. If the resolution of the image is high enough, feature information of the physiological feature can be extracted from the image. Then, a corresponding physiological feature can be composed according to the extracted feature information. For example, a fingerprint can be composed by using corresponding fingerprint information. The composed physiological feature can be copied or transmitted, thereby leaking the personal information and exposing the individual and the general public to security risks.

### BRIEF SUMMARY OF THE INVENTION

In view of this situation, the present invention proposes an image processing method, a photographing device and a storage medium. The image processing method of the present invention can solve the problem of the leakage of personal information due to the high resolution of captured images.

In order to achieve the aforementioned purpose, an image processing method of a photographing device is provided in the invention. The image processing method comprises: determining whether a physiological feature in a current collection area needs to be detected according to a photographing parameters of a lens during capturing; directly storing an image captured from the current collection area when the physiological feature in the current collection area does not need to be detected; or detecting the physiological feature in the current collection area and processing the captured image when the physiological feature in the current collection area needs to be detected.

The step of detecting the physiological feature in the current collection area and processing the captured image further comprises: detecting whether the physiological feature is included in the current collection area; and performing an un-recognition process on the physiological feature and storing the processed image when the physiological feature is included in the current collection area; or directly storing the captured image when the physiological feature is not included in the current collection area.

The un-recognition process comprises: performing a blur-focusing process on the physiological feature during capturing; performing other focusing or blur process during capturing such that the physiological feature cannot be clearly focused; or performing a blur process on the physiological feature during storing the captured image.

The step of determining whether the physiological feature in the current collection area needs to be detected according to photographing parameters of the lens comprises: determining whether the captured image can be used for recognizing the physiological feature according to the photographing parameters of the lens; and the physiological feature in the current collection area needs to be detected when the captured image can be used for recognizing the physiological feature; or the physiological feature in the current collection area does not need to be detected when the captured image cannot be used for recognizing the physiological feature.

After the step of detecting the physiological feature in the current collection, the method further comprises: determining whether the physiological feature is recognizable; and performing the step of processing the captured image when the physiological feature is recognizable; or directly storing the captured image when the physiological feature is not recognizable.

The step of determining whether the physiological feature is recognizable further comprises: extracting image information of the physiological feature in the current collection area; determining whether there is available feature information in a new physiological feature which is re-composed of the image information of the physiological feature; and determining that the physiological feature is recognizable when there is available feature information; or determining that the physiological feature is not recognizable when there is no available feature information.

The image processing method further comprises: obtaining a stored image of the photographing device; determining whether the physiological feature in the stored image needs to be detected according to image information of the stored image; and the stored image is not processed when the physiological feature in the stored image does not need to be detected; or the physiological feature in the stored image is detected and the stored image is processed when the physiological feature in the stored image needs to be detected.

The step of detecting the physiological feature in the stored image further comprising: detecting whether the stored image includes the physiological feature; and performing an un-recognition process on the physiological feature of the stored image and performing a corresponding operation on the processed image according to a corresponding operation instruction when the stored image includes the physiological feature; or directly performing the corresponding operation on the stored image according to the corresponding operation instruction when the stored image does not include the physiological feature, wherein the operation instruction includes a transmitting instruction, a sharing instruction, a display instruction, and/or a storing instruction.

The step of performing the un-recognition process on the physiological feature in the stored image further comprising: performing a blur process on the physiological feature; or covering the physiological feature with a mask.

On the other hand, another image processing method of a photographing device is provided in the present invention. The method comprises: detecting whether a physiological feature is included in a current collection area of a lens during capturing; and processing an image captured from the current collection area when there is a physiological feature in the current collection area of the lens; or directly storing the captured image when the physiological feature is not included in the current collection area of the lens.

After the step of detecting that the physiological feature is included in the current collection area of the lens, the method further comprises: determining whether the physiological feature is recognizable; and performing the step of processing the captured image in the current collection area when the physiological feature is recognizable; or directly storing the captured image when the physiological feature is not recognizable.

The step of determining whether the physiological feature is recognizable further comprises: extracting image information of the physiological feature in the current collection area; determining whether there is available feature information in a new physiological feature which is re-composed of the image information of the physiological feature; and determining that the physiological feature is recognizable when there is available feature information; or determining that the physiological feature is not recognizable when there is no available feature information.

On the other hand, a photographing device is provided in the present invention. The photographing device comprises a processor, a lens and a memory; wherein the processor is coupled to the memory and the lens, respectively; the lens is arranged to capture an image from a current collection area according to a capturing instruction; the memory is arranged to store computer instructions executed by the processor and the image captured by the lens; the processor is arranged to determine whether a physiological feature in a current collection area of the captured image needs to be detected according to photographing parameters of the lens; and directly store the captured image when the physiological feature in the current collection area is determined not to be detected; or detect the physiological feature in the current collection area and process the captured image when the physiological feature in the current collection area is determined to be detected.

Detect the physiological feature in the current collection area and process the captured image further comprises: detect whether the physiological feature is included in the current collection area; and perform an un-recognition process on the physiological feature and store the processed image when the physiological feature is included in the current collection area; or directly store the captured image when the physiological feature is not included in the current collection area.

The un-recognition process comprises: perform a blur-focusing process on the physiological feature during capturing; perform other focusing or blur process during capturing such that the physiological feature cannot be clearly focused; or perform a blur process on the physiological feature during storing the captured image.

Determine whether a physiological feature in a current collection area of the captured image needs to be detected according to photographing parameters of the lens comprises: determine whether the captured image can be used for recognizing the physiological feature according to the photographing parameters of the lens; and the physiological feature in the current collection area needs to be detected when the captured image can be used for recognizing the physiological feature; or the physiological feature in the current collection area does not need to be detected when the captured image cannot be used for recognizing the physiological feature.

After detect the physiological feature in the current collection, the processor is further arranged to: determine whether the physiological feature is recognizable; and process the captured image when the physiological feature is recognizable; or directly store the captured image when the physiological feature is not recognizable.

Determine whether the physiological feature is recognizable further comprises: extract image information of the physiological feature in the current collection area; determine whether there is available feature information in a new physiological feature which is re-composed of the image information of the physiological feature; and determine the physiological feature is recognizable when there is available feature information; or determine the physiological feature is not recognizable when there is no available feature information.

On the other hand, a photographing device is provided in the present invention. The photographing device comprises a processor, a lens and a memory; wherein the processor is coupled to the memory and the lens, respectively; the lens is arranged to capture an image from a current collection area according to a capturing instruction; the memory is arranged to store computer instructions executed by the processor and the image captured by the lens; the processor is arranged to detect whether a physiological feature is included in the current collection area of the lens; and process an image captured from the current collection area when the physiological feature is included in the current collection area of the lens; or directly store the captured image when the physiological feature is not included in the current collection area of the lens.

The processor is further arranged to determine whether the physiological feature is recognizable; and process the captured image in the current collection area when the physiological feature is recognizable; or directly store the captured image when the physiological feature is not recognizable.

Beneficial Effects compared with the prior art: in the invention, the captured image can be directly processed during capture so that the physiological feature in the image cannot be recognized. The security of the captured image can be improved and thereby the personal privacy of the user can be protected.

### BRIEF DESCRIPTION OF THE DRAWINGS

FIG. 1 is a schematic flow diagram illustrating an image processing method of a photographing device according to the first embodiment of the present invention.

FIG. 2 is a schematic flow diagram of step S11 in FIG. 1.

FIG. 3 is a flow diagram of step S12 in FIG. 2.

FIG. 4 is a schematic flow diagram illustrating an image processing method of a photographing device according to the second embodiment of the present invention.

FIG. 5 is a schematic flow diagram illustrating an image processing method of a photographing device according to the third embodiment of the present invention.

FIG. 6 is a schematic flow diagram illustrating an image processing method of a photographing device according to the fourth embodiment of the present invention.

FIG. 7 is a schematic structural diagram illustrating a photographing device according to an embodiment of the present invention.

FIG. 8 is a schematic structural diagram illustrating a photographing device according to another embodiment of the present invention.

FIG. 9 is a schematic structural diagram illustrating an intelligent terminal according to an embodiment of the present invention.

FIG. 10 is a schematic structural diagram illustrating a storage medium according to an embodiment of the present invention.

### DETAILED DESCRIPTION OF THE INVENTION

For a person skilled in the art to better understand the technical solutions in the application, an image processing method, a photographing device and a storage medium provided in the application will be described thoroughly in more detail with reference to the figures herein.

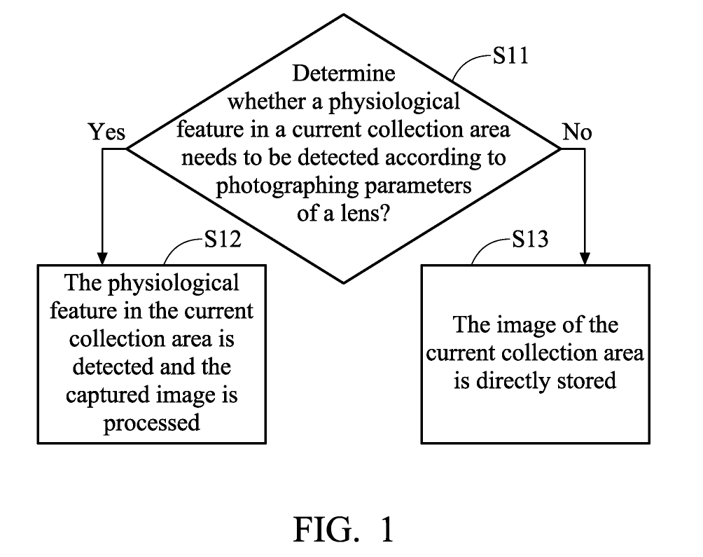

Referring to FIG. 1, FIG. 1 is a schematic flow diagram illustrating an image processing method of a photographing device according to the first embodiment of the present invention. As shown in FIG. 1, the image processing method in the embodiment may comprise the following steps.

In step S11, it is determined whether a physiological feature in a current collection area needs to be detected according to photographing parameters of a lens.

The photographing parameters of the lens are directly related to the resolution of an image captured by the photographing device. For example, different pixels, aperture, focal length, caliber of the lens and other photographing parameters may result in different resolutions of the captured image. In addition, for the photographing device, which provides photographing modes, the photographing parameters of the lens may further include photographing mode setting. Using a photographing mode corresponding to a particular environment may improve the resolution of the image captured by the lens.

In the embodiment, firstly, it is determined whether the physiological feature in the current collection area needs to be detected according to the photographing parameters of the lens during capture. Then, step S12 or S13 is selected to be executed according to the determination result. The physiological feature of the embodiment includes fingerprints, palm prints, irises, and other physiological feature which can be used for recognizing a user. When the image is clear enough, feature information of the physiological feature can be obtained from the captured image, wherein the feature information can be copied.

In step S12, the physiological feature in the current collection area is detected and the captured image is processed.

When the determination result in step S11 is that the physiological feature in the current collection area needs to be detected (for example, it may be determined that the resolution of the captured image is higher and/or a focus distance from the lens to a photographed person is closer and so on according to the photographing parameters of the lens), step S12 is executed and the physiological feature in the current collection area is detected. In the embodiment, step S12 is executed after the photographing device captures the image to be stored from the current collection area. That is, the photographing device detects the physiological feature of the image to be stored, wherein the image is captured from the current collection area. After the physiological feature in the image to be stored is detected, the image is processed so that the physiological feature of the image cannot be recognized.

In the embodiment, the sentence “the physiological feature cannot be recognized” means that the complete feature information of the physiological feature cannot be obtained by using the image information of the physiological feature in the image. For example, when a fingerprint is included in the image, the complete fingerprint information cannot be re-obtained by using the fingerprint in the image. At this time, the fingerprint composed by using the image information is incomplete or blurred. A pattern of the fingerprint and other features on the fingerprint cannot be fully shown, or the pattern of the fingerprint and other features shown on the fingerprint are blurred.

In step S13, the image of the current collection area is directly stored.

When the determination result of step S11 is that the physiological feature in the current collection area does not need to be detected, for example, it can be determined that the resolution of the captured image is low, the background light is very bright and/or the focus distance from the lens to the photographed person is far and so on according to the photographing parameters, (that is, the captured image may not include clear feature information of the physiological feature, and the complete feature information of the physiological feature cannot be re-composed or obtained by using the image information of the physiological feature in the image) the image is directly stored without been processed.

In the embodiment, when the physiological feature in the current collection area of the image captured by the lens needs to be detected, the captured image is processed so that the physiological feature in the captured image cannot be recognized. The safety of the captured image can be improved and the personal privacy of the user can be protected.

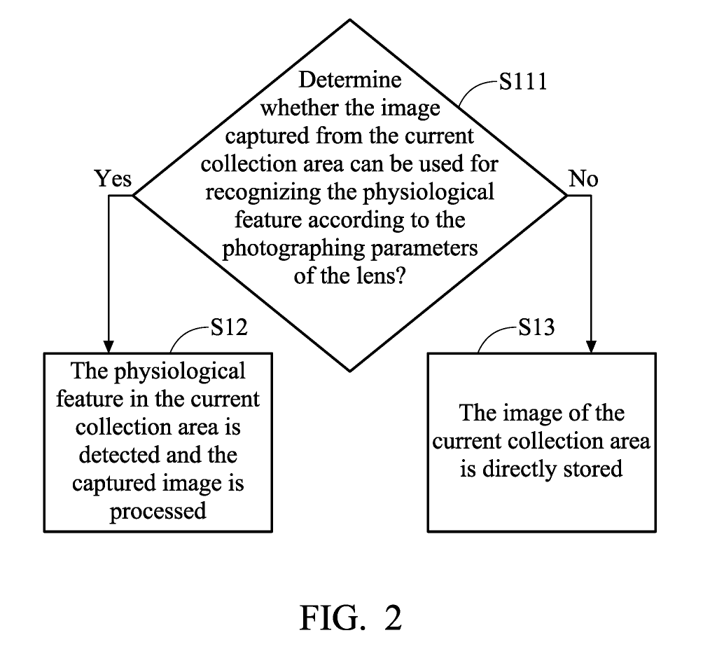

Furthermore, referring to FIG. 2. FIG. 2 is a schematic flow diagram of step S11 in FIG. 1. As shown in FIG. 2, step S11 may comprise the following steps.

In step S111, it is determined whether the image captured from the current collection area can be used for recognizing the physiological feature according to the photographing parameters of the lens.

The photographing parameters of the lens are directly related to the resolution of an image captured by the photographing device, and whether the image is clear is directly related to whether the physiological feature in the image can be recognized. It should be understood that since the physiological feature included in the image having higher resolution is clearer, the physiological feature in the image can be recognized. Since the physiological feature included in the image having lower resolution is more blurred, the physiological feature in the image cannot be recognized.

In the embodiment, the resolution of the captured image can be obtained according to the photographing parameters of the lens, and the resolution of the image can be used to determine whether the image can be used for recognizing the physiological feature. When the resolution of the image is high enough, the image can be used for recognizing the physiological feature. When the resolution of the image is low (or not high enough), the image cannot be used for recognizing the physiological feature.

In the embodiment, preset thresholds can be set for the photographing parameters of the lens. When the photographing parameters of the lens reach the preset thresholds, it is considered that the resolution of the captured image is sufficient to be used for recognizing the physiological feature. On the other hand, when the photographing parameters of the lens do not reach the preset thresholds, it is considered that the resolution of the captured image is not high enough to be used for recognizing the physiological feature. It should be understood that the photographing parameters of the lens include pixels, aperture, focal length, caliber of the lens and so on. Therefore, the corresponding preset threshold can be set for each photographing parameter, such as a pixel threshold, an aperture threshold, a focal length threshold and so on. The sentence “the photographing parameters of the lens reach the preset thresholds” means that all photographing parameters of the lens reach their corresponding preset thresholds. When one of the photographing parameters of the lens does not reach its corresponding preset threshold, the photographing parameters of the lens do not reach the preset thresholds.

In the embodiment, the subsequent step is selected to be executed according to the determination result of step S111. When the image captured from the current collection area by the lens can be used for recognizing the physiological feature, it is considered that the physiological feature in the current collection area needs to be detected, and step S12 is executed correspondingly; when the determination result in step S111 is that the image captured from the current collection area by the lens cannot be used for recognizing the physiological feature, it is considered that the physiological feature in the current collection area does not need to be detected, and step S13 is executed correspondingly.

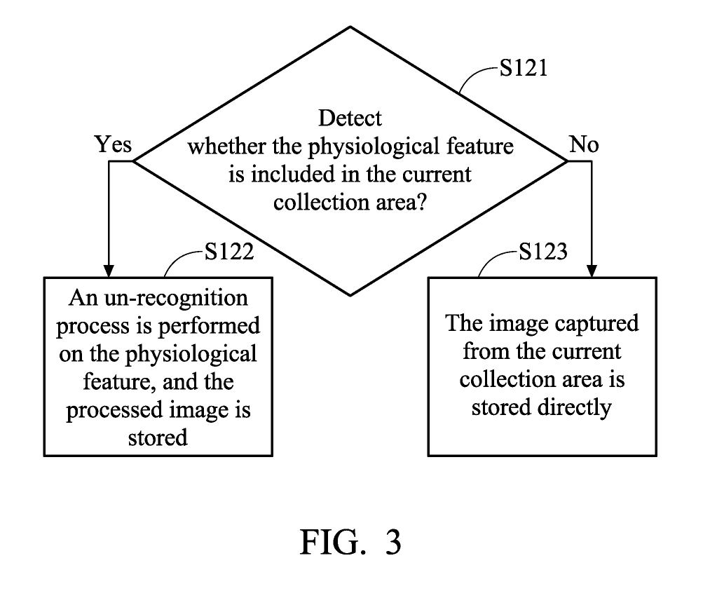

Moreover, referring to FIG. 3. FIG. 3 is a flow diagram of step S12 in FIG. 2. Step S12 may include the following steps.

In step S121, it is detected whether the physiological feature is included in the current collection area.

It can be known whether the image captured by the lens can be used for recognizing the physiological feature through step S11, but it cannot be determined whether the physiological feature is included in the captured image. Therefore, step S12 is used to detect whether the physiological feature is included in the image.

When the detecting result in step S11 is that the physiological feature in the current collection area needs to be detected, it is further detected whether the physiological feature is included in the current collection area. It should be understood that when the photographing device captures the current collection area, the captured image will exist in the form of the image to be stored since the captured image is not directly stored. Therefore, in the embodiment, detecting whether the physiological feature is included in the image to be stored, and thereby detecting whether the physiological feature is included in the current collection area can be implemented. When the physiological feature is included in the captured image to be stored, a corresponding physiological feature is included in the corresponding current collection area and step S122 is executed; when the physiological feature is not included in the captured image to be stored, the corresponding physiological feature is not included in the corresponding current collection area and step S123 is executed.

In step S122, an un-recognition process is performed on the physiological feature, and the processed image is stored.

When the detecting result in step S121 is that the physiological feature is included in the current collection area, the un-recognition process is performed on the physiological feature in the captured image to be stored. As a result, even though the physiological feature in the final stored image is re-composed, the feature information which can be recognized cannot be obtained by using the re-composed physiological feature. In the embodiment, the un-recognition process performed on the physiological features comprises: a blur-focusing process is performed on the physiological feature during capturing; other focusing or blur process is performed during capturing such that the physiological feature cannot be clearly focused; a blur process is performed on the physiological feature in the captured image to be stored; or the physiological feature in the captured image to be stored is covered with a mask.

For example, during capturing, performing the blur-focusing process on the physiological feature or performing other focusing or blur process can reduce the resolution of the physiological feature in the captured image to be stored. Therefore, a clear physiological feature cannot be obtained by using the captured image. The blur process which is performed on the physiological feature can reduce the resolution of the physiological feature in the images. Consequently, a clear physiological feature cannot be obtained by using the captured image, and the personal privacy of the photographed person is not leaked through the physiological feature.

Covering the physiological feature with a mask means that the feature information of the physiological feature cannot be obtained from the processed image, so that the personal privacy of the photographed person is not leaked through the physiological feature. In the embodiment, in order not to affect the final stored image, the mask covered over the physiological feature in the image may not be transparent but may have a color which is close to that of the skin. In this manner, the physiological feature of the image can be covered and the quality of the overall picture of the final stored image is not affected. The processed image is stored after the physiological feature in the image is processed.

For example, when a fingerprint is included in the captured image, a blur process is performed on the fingerprint in the image. The resolution of the fingerprint in the image is reduced by the blur process. Even using the image information of the fingerprint in the image, a clear fingerprint cannot be obtained. In addition, it is also possible to place a mask over the fingerprint in the image. The mask can cover the original fingerprint in the image so that the image information of the fingerprint cannot be obtained through the processed image, and the fingerprint cannot even be re-composed by using the image information of the fingerprint.

In step S123, the image captured from the current collection area is stored directly.

When the detecting result in step S121 is that the physiological feature is not included in the current collection area (that is, the risk of the leakage of the personal privacy of the photographed person through the physiological feature does not exist in the image), the captured image does not need to be processed and may be stored directly.

In the embodiment, it is determined whether the physiological feature in the image captured from the current collection area needs to be detected according to the photographing parameters of the lens. When the captured image has a higher resolution due to the photographing parameters of the lens and the physiological feature which is recognizable can be obtained from the captured image, the captured image is processed so that the physiological feature of the captured image cannot be recognized. Therefore, a clear and recognizable physiological feature cannot be obtained from the captured image, and thereby the safety of the captured image can be improved and the risk of the leakage of the personal privacy of the user through the captured image is reduced.

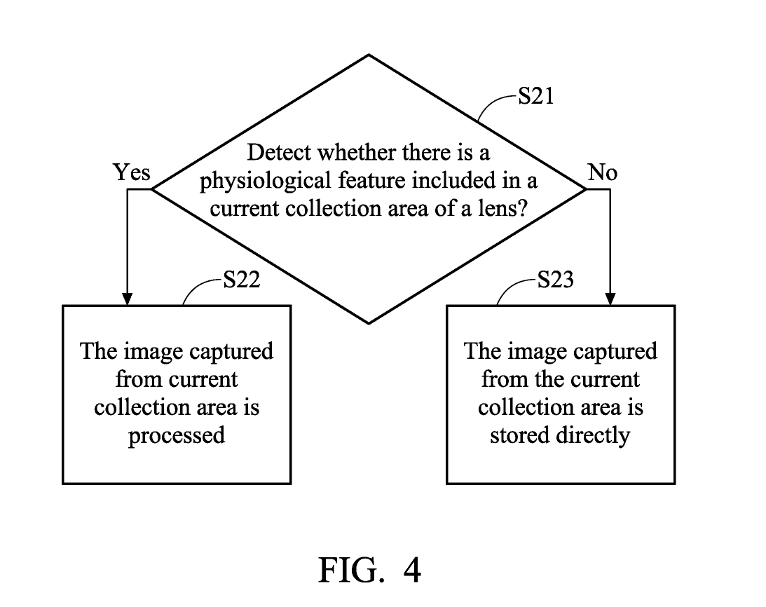

Furthermore, referring to FIG. 4. FIG. 4 is a schematic flow diagram illustrating an image processing method of a photographing device according to the second embodiment of the present invention. As shown in FIG. 4, the image processing method in the embodiment may include the following steps.

In step S21, it is detected whether there is a physiological feature included in a current collection area of a lens. During capturing, it is detected whether the physiological feature is included in the current collection area of the lens by the lens capturing the image from the current collection area. Then, step S22 or S23 is selected to be executed according to the detecting result of step S21.

In step S22, the image captured from current collection area is processed.

When the detecting result in step S21 is that the physiological feature is included in the current collection area of the lens (that is, the physiological feature is also included in the corresponding captured image, and the risk of the leakage of the personal privacy of the user through the physiological feature exists in the captured image), the captured image is processed to prevent the physiological feature in the image captured from being recognized.

In the embodiment, the step of processing the captured image comprises: performing a blur-focusing process on the physiological feature during capturing; performing other focusing or blur process during capturing such that the physiological feature cannot be clearly focused; or performing a blur process on the physiological feature of the captured image; or covering the physiological feature of the captured image with a mask. The processing method in step S22 is similar to those in step S122, so details will be omitted.

In step S23, the image captured from the current collection area is stored directly.

When the detecting result in step S21 is that the physiological feature is not included in the current collection area (that is, the physiological feature is also not included in the corresponding captured image, and the risk of the leakage of the personal privacy of the user through the physiological feature does not exist in the captured image), the captured image does not need to be processed and may be stored directly.

Furthermore, referring to FIG. 5. FIG. 5 is a schematic flow diagram illustrating an image processing method of a photographing device according to the third embodiment of the present invention. The embodiment of FIG. 5 is a modification based on the image processing method of the second embodiment shown in FIG. 4. As shown in FIG. 5, after the physiological feature is detected in the current collection area of the lens in step S21, the embodiment also comprises the following steps.

In step S24, it is determined whether the physiological feature may be recognized.

Different images have different resolutions because the images have different pixels or other problems. The physiological feature in the image whose resolution is lower may not be recognized even though the physiological feature is included in the image. To save execution time and computation quantity for the method in the embodiment, it is further determined whether the physiological feature can be recognized and the subsequent step is selected to be executed according to the determination result of step S24, when the detecting result in step S21 is that the physiological feature is included in the image.

In the embodiment, the step of determining whether the physiological feature can be recognized comprises: extracting the image information from the physiological feature in the current collection area, and determining whether there is available feature information in a new physiological feature which is re-composed of the image information of the physiological feature. For example, whether a clear pattern of the fingerprint can be obtained from the re-composed fingerprint and so on.

When the determination result of the step S24 is that the physiological feature in the image can be recognized, step S22 is executed for processing the captured image to cause the physiological feature of the image not to be recognized. In the embodiment, the step of processing the captured image comprises the blur process performed on the physiological feature or covering the physiological feature in the image with a mask.

When the determination result of the step S24 is that the physiological feature in the image cannot be recognized (that is, the captured image does not need to be processed), step S23 is executed and the captured image is directly stored.

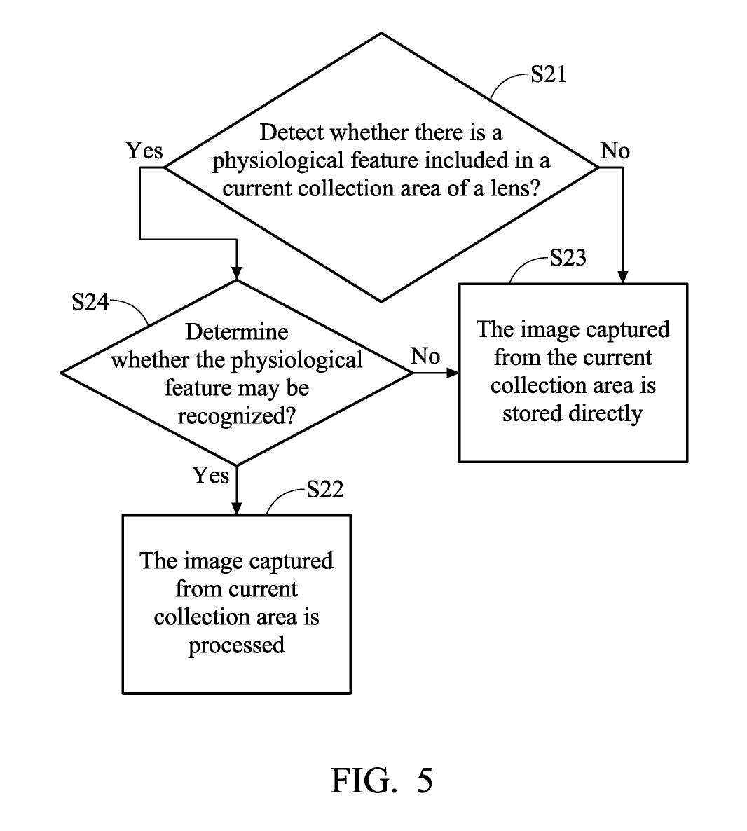

Referring to FIG. 6, FIG. 6 is a schematic flow diagram illustrating an image processing method of a photographing device according to the fourth embodiment of the present invention. As shown in FIG. 6, the image processing method may comprise the following steps.

In step S31, the image stored in the photographing device is obtained.

A photographing device which is generally known provides a storage function to store the captured images. In addition, the photographing device may also receive and store the images transmitted to or transferred from other devices. The physiological features in these images may not be processed. In the embodiment, the image, which includes unprocessed physiological feature, is processed. The image stored in the memory of the photographing device is accessed, wherein the stored image may be an image transferred to or transmitted from other devices or captured by the photographing device itself.

In step S32, it is determined whether the physiological feature of the stored image needs to be detected according to the image information of the stored image.

In the embodiment, the corresponding image information is extracted from the stored image, and it is determined whether the physiological feature in the stored image needs to be detected according to the image information. Specifically, it is possible to know whether the physiological feature which is recognizable is included in the stored image according to the resolution of the stored image obtained from the image information in the stored image. It should be understood that when the resolution of the stored image is too low, the physiological feature of the stored image does not need to be detected (that is, the physiological feature is blurred and unrecognizable even though the physiological feature is included in the image); when the resolution of the stored image is higher (that is, the risk of the leakage of the personal privacy of the user through the physiological feature may be exist in the stored image), the physiological feature of the stored image needs to be detected.

In the embodiment, a resolution threshold can be set. When the resolution of the stored image is higher than or equal to the resolution threshold, it is determined that the stored image can be used for recognizing the physiological feature so that the physiological feature of the stored image needs to be detected. When the resolution of the stored image is lower than the resolution threshold, it is determined that the stored image cannot be used for recognizing the physiological feature so that the physiological feature of the stored image does not need to be detected.

In step S33, a corresponding operation is performed on the stored image according to a corresponding operation instruction.

When the determination result in step S32 is that the physiological feature of the stored image does not need to be detected (that is, the resolution of the stored image is not high enough to obtain clear feature information of the physiological feature, and the risk of the leakage of the personal privacy of the user through the physiological feature does not exist in the stored image), the stored image does not need to be processed and the corresponding operation is directly performed on the stored image according to a corresponding operation instruction.

In the embodiment, the operation instruction includes a transmitting instruction, a sharing instruction, a display instruction, and/or a storing instruction. The stored image may be transmitted, shared, displayed and/or stored according to the operation instruction.

In step S34, the physiological feature of the stored image is detected and the stored image is processed.

When the determination result in step S32 is that the physiological feature of the stored image needs to be detected (that is, if the physiological feature is included in the stored image, a clear and recognizable feature information of the physiological feature can be obtained from the stored image according to the resolution of the stored image, wherein the clear and recognizable feature information can be re-composed by using the image information of the stored image), the physiological feature of the stored image is detected, the stored image is processed and the processed image is stored.

In the embodiment, the step of processing the stored image may comprise the blur process performed on the physiological feature of the stored image or covering the physiological feature with a mask and so on. The method for processing the stored image is not specifically limited in the embodiment, and may cause the physiological feature in the stored image to be not recognized.

It should be understood that, in other embodiments, it can still be detected whether the physiological feature is included in the stored image after obtaining the stored image of the photographing device in step S31. When the physiological feature is included in the stored image, it is further determined whether the physiological feature in the stored image is recognizable. When the physiological feature of the stored image is recognizable, step S34 is executed, the physiological feature of the stored image is detected and the stored image is processed. When the physiological feature is not included in the stored image or the physiological feature in the stored image is unrecognizable, step S33 is executed and the corresponding operation is performed on the stored image according to the corresponding operation instruction. The step of detecting whether the physiological feature in the stored image is recognizable can comprise: extracting the image information of the physiological feature from the stored image, and determining whether the new physiological feature which is re-composed of the extracted image information of the physiological feature is recognizable.

It should be understood that the first embodiment to the fourth embodiment of the image processing method shown in FIG. 1 to FIG. 6 can be applied to the photographing device. Furthermore, the fourth embodiment of the image processing method in FIG. 6 can also be applied to an intelligent terminal which cannot support a photographing function, such as a computer terminal, a cell phone and an electronic reader which does have a camera.

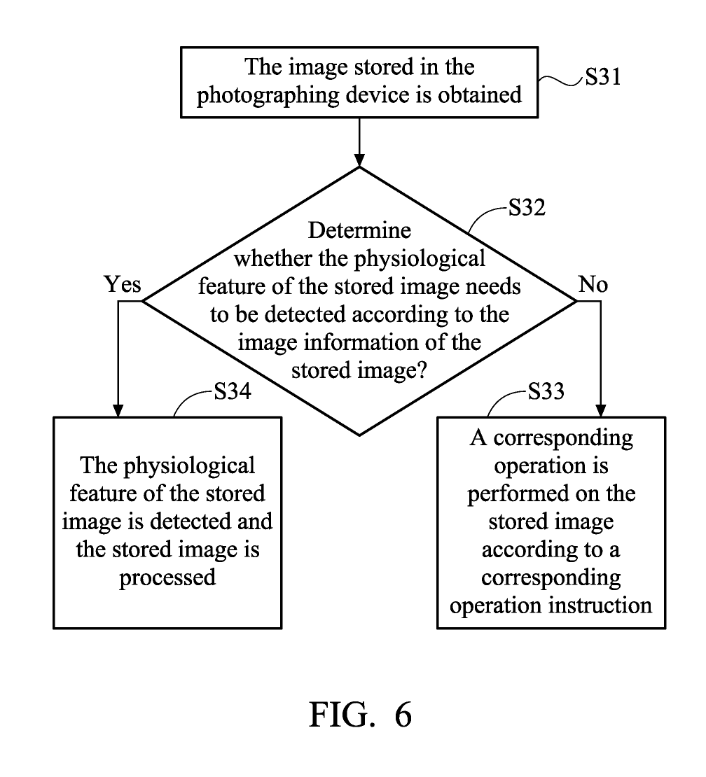

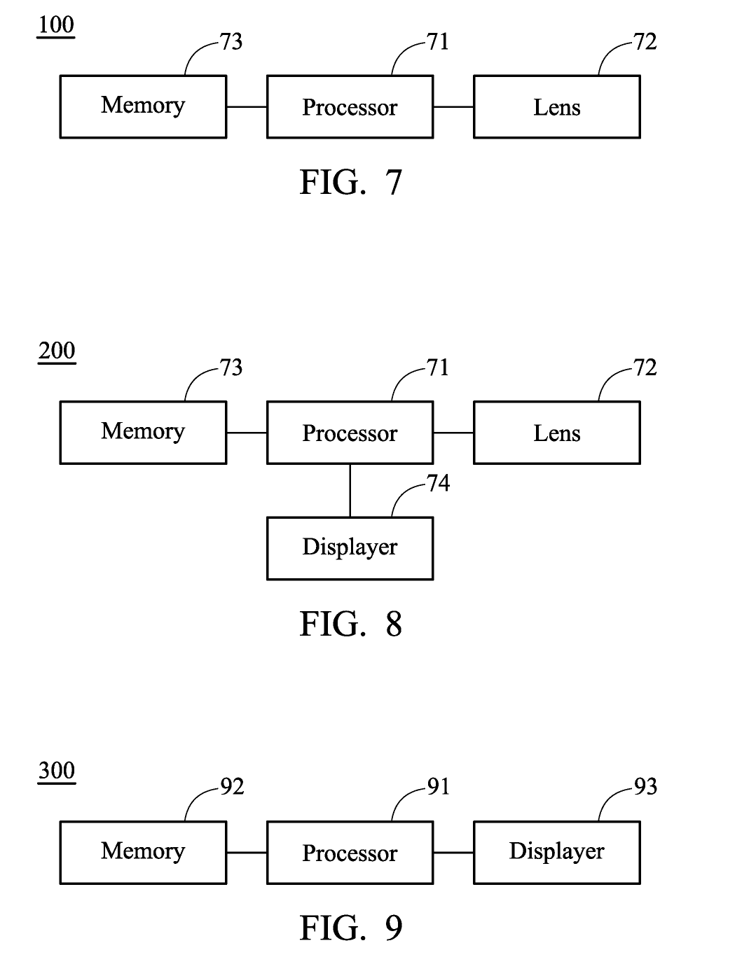

Referring to FIG. 7, FIG. 7 is a schematic structural diagram illustrating a photographing device according to an embodiment of the present invention. As shown in FIG. 7, the photographing device 100 comprises a processor 71, a lens 72 and a memory 73. The processor 71 is coupled to the memory 73 and the lens 72, respectively. The lens 72 captures an image from a current collection area according to a capturing instruction. The memory 73 is configured to store computer instructions executed by the processor 71 and images captured by the lens 72. The processor 71 executes the computer instructions stored in the memory 73 to implement any one of the image processing methods in the first embodiment to the fourth embodiment shown in FIG. 1 to FIG. 6. The detailed description of each step in the image processing methods is shown in the first embodiment to the fourth embodiment of the image processing methods, so details will be omitted.

Furthermore, as shown in FIG. 8, the photographing devices may further comprise a displayer 74 according to the embodiment. The displayer 74 is connected to the processor 71 and used to display the stored image obtained from the memory 73 or the image captured by the lens 72.

Referring to FIG. 9, FIG. 9 is a schematic structural diagram illustrating an intelligent terminal according to an embodiment of the present invention. As shown in FIG. 9, the intelligent terminal 300 comprises a processor 91, a memory 92 and a displayer 93. The processor 91 is coupled to the memory 92 and the displayer 93, respectively. The memory 92 is configured to store the images and the computer instructions executed by the processor 91. The displayer 93 is configured to display the images stored in the memory 92. The processor 91 is configured to execute the computer instructions to implement the fourth embodiment of the image processing method shown in FIG. 6. The detailed description of each step in the image processing methods is shown in the first embodiment to the fourth embodiment of the image processing methods, so details will be omitted.

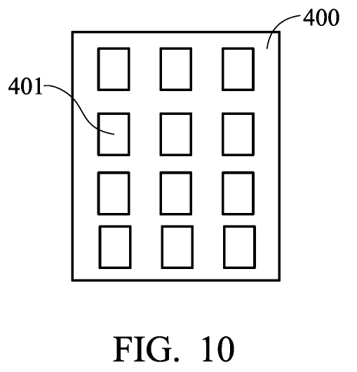

Furthermore, referring to FIG. 10, FIG. 10 is a schematic structural diagram illustrating a storage medium according to an embodiment of the present invention. As shown in FIG. 10, the storage medium 400 stores program data 401. The program data 401 can be executed to implement any one of the methods of the first embodiment to the fourth embodiment of the image processing methods shown in FIG. 1 to FIG. 6. The storage medium in the embodiment may be a memory chip, a hard disk, a mobile hard disk, a USB flash drive, an optical disk or other computer readable storage medium, as well as a server and so on.

It should be understood that the above embodiment of the present invention is described for illustration purpose only and will not limit the scope of the present invention, and various modifications and alternations can be made on the present invention by those skilled in the art with reference to the specification and drawings of the present invention, and these equivalent modifications and alternations or any direct or indirect applications of the present invention in other relevant technical fields still fall within the scope of the claims of the present invention.

What is claimed is:

1. An image processing method of a photographing device, comprising:
determining whether a physiological feature in a current collection area needs to be detected according to photographing parameters of a lens during capturing; and
directly storing an image captured from the current collection area when the physiological feature in the current collection area does not need to be detected; or
detecting the physiological feature in the current collection area and processing the captured image when the physiological feature in the current collection area needs to be detected.

2. The image processing method as claimed in claim 1, wherein the step of detecting the physiological feature in the current collection area and processing the captured image further comprises:
detecting whether the physiological feature is included in the current collection area; and
performing an un-recognition process on the physiological feature and storing the processed image when the physiological feature is included in the current collection area; or
directly storing the captured image when the physiological feature is not included in the current collection area.

3. The image processing method as claimed in claim 2, wherein the un-recognition process comprises:
performing a blur-focusing process on the physiological feature during capturing;
performing other focusing or blur process during capturing such that the physiological feature cannot be clearly focused; or performing a blur process on the physiological feature during storing the captured image.

4. The image processing method as claimed in claim 1, wherein the step of determining whether the physiological feature in the current collection area needs to be detected according to photographing parameters of the lens comprises:
determining whether the captured image can be used for recognizing the physiological feature according to the photographing parameters of the lens; and
the physiological feature in the current collection area needs to be detected when the captured image can be used for recognizing the physiological feature; or
the physiological feature in the current collection area does not need to be detected when the captured image cannot be used for recognizing the physiological feature.

5. The image processing method as claimed in claim 1, wherein after the step of detecting the physiological feature in the current collection, the method further comprises:
determining whether the physiological feature is recognizable; and
performing the step of processing the captured image when the physiological feature is recognizable; or
directly storing the captured image when the physiological feature is not recognizable.

6. The image processing method as claimed in claim 5, wherein the step of determining whether the physiological feature is recognizable further comprises:
extracting image information of the physiological feature in the current collection area;
determining whether there is available feature information in a new physiological feature which is re-composed of the image information of the physiological feature; and
determining that the physiological feature is recognizable when there is available feature information; or
determining that the physiological feature is not recognizable when there is no available feature information.

7. The image processing method as claimed in claim 1, further comprising:
obtaining a stored image of the photographing device;
determining whether the physiological feature in the stored image needs to be detected according to image information of the stored image; and
the stored image is not processed when the physiological feature in the stored image does not need to be detected; or
the physiological feature in the stored image is detected and the stored image is processed when the physiological feature in the stored image needs to be detected.

8. The image processing method as claimed in claim 7, wherein the step of detecting the physiological feature in the stored image further comprises:
detecting whether the stored image includes the physiological feature; and
performing an un-recognition process on the physiological feature of the stored image and performing a corresponding operation on the processed image according to a corresponding operation instruction when the stored image includes the physiological feature; or
directly performing the corresponding operation on the stored image according to the corresponding operation instruction when the stored image does not include the physiological feature, wherein the operation instruction includes a transmitting instruction, a sharing instruction, a display instruction, and/or a storing instruction.

9. The image processing method as claimed in claim 8, wherein the step of performing the un-recognition process on the physiological feature of the stored image further comprises:
performing a blur process on the physiological feature; or covering the physiological feature with a mask.

10. An image processing method of a photographing device, comprising:
detecting whether a physiological feature is included in a current collection area of a lens during capturing; and
processing an image captured from the current collection area when the physiological feature is included in the current collection area of the lens; or
directly storing the captured image when the physiological feature is not included in the current collection area of the lens.

11. The image processing method as claimed in claim 10, wherein after the step of detecting that the physiological feature is included in the current collection area of the lens, the method further comprises:
determining whether the physiological feature is recognizable; and
performing the step of processing the captured image in the current collection area when the physiological feature is recognizable; or
directly storing the captured image when the physiological feature is not recognizable.

12. The image processing method as claimed in claim 11, wherein the step of determining whether the physiological feature is recognizable further comprises:
extracting image information of the physiological feature in the current collection area;
determining whether there is available feature information in a new physiological feature which is re-composed of the image information of the physiological feature; and
determining that the physiological feature is recognizable when there is available feature information; or
determining that the physiological feature is not recognizable when there is no available feature information.

13. A photographing device, comprising:
a processor, a lens and a memory;
wherein the processor is coupled to the memory and the lens, respectively;
the lens is arranged to capture an image from a current collection area according to a capturing instruction;
the memory is arranged to store computer instructions executed by the processor and the image captured by the lens;
the processor is arranged to determine whether a physiological feature in a current collection area of the captured image needs to be detected according to photographing parameters of the lens; and directly store the captured image when the physiological feature in the current collection area is determined not to be detected; or detect the physiological feature in the current collection area and process the captured image when the physiological feature in the current collection area is determined to be detected.

14. The photographing device as claimed in claim 13, wherein detect the physiological feature in the current collection area and process the captured image further comprises:
detect whether the physiological feature is included in the current collection area; and
perform an un-recognition process on the physiological feature and store the processed image when the physiological feature is included in the current collection area; or
directly store the captured image when the physiological feature is not included in the current collection area.

15. The photographing device as claimed in claim 14, wherein the un-recognition process comprises:
perform a blur-focusing process on the physiological feature during capturing;
perform other focusing or blur process during capturing such that the physiological feature cannot be clearly focused; or perform a blur process on the physiological feature during storing the captured image.

16. The photographing device as claimed in claim 13, wherein determine whether a physiological feature in a current collection area of the captured image needs to be detected according to photographing parameters of the lens comprises:
determine whether the captured image can be used for recognizing the physiological feature according to the photographing parameters of the lens; and
the physiological feature in the current collection area needs to be detected when the captured image can be used for recognizing the physiological feature; or
the physiological feature in the current collection area does not need to be detected when the captured image cannot be used for recognizing the physiological feature.

17. The photographing device as claimed in claim 13, wherein after detect the physiological feature in the current collection, the processor is further arranged to:
determine whether the physiological feature is recognizable; and
process the captured image when the physiological feature is recognizable; or
directly store the captured image when the physiological feature is not recognizable.

18. The photographing device as claimed in claim 17, wherein determine whether the physiological feature is recognizable further comprises:
extract image information of the physiological feature in the current collection area;
determine whether there is available feature information in a new physiological feature which is re-composed of the image information of the physiological feature; and
determine the physiological feature is recognizable when there is available feature information; or
determine the physiological feature is not recognizable when there is no available feature information.

19. A photographing device, comprising:
a processor, a lens and a memory;
wherein the processor is coupled to the memory and the lens, respectively;
the lens is arranged to capture an image from a current collection area according to a capturing instruction;
the memory is arranged to store computer instructions executed by the processor and the image captured by the lens;
the processor is arranged to detect whether a physiological feature is included in the current collection area of the lens; and process an image captured from the current collection area when the physiological feature is included in the current collection area of the lens; or directly store the captured image when the physiological feature is not included in the current collection area of the lens.

20. The photographing device as claimed in claim 19, wherein the processor is further arranged to determine whether the physiological feature is recognizable; and process the captured image in the current collection area when the physiological feature is recognizable; or directly store the captured image when the physiological feature is not recognizable.
